(19) United States
(12) Patent Application Publication
(10) Pub. No.: US 2026/0071984 A1
(43) Pub. Date: Mar. 12, 2026

(54) Method and Device for Evaluating a Measuring Signal of a Thermal Analysis, Method and a Device for Generating Training Data, and Method and Device for Generating Training Data for an Artificial Intelligence Module

(71) Applicant: NETZSCH-Gerätebau GmbH, Selb (DE)

(72) Inventors: Nico Dilsch, Höchstädt (DE); Andreas Strobel, Auerbach (DE); Michael Schöneich, Selb (DE); Thilo Hilpert, Selb (DE); Fabian Wohlfahrt, Rehau (DE); Martin Brunner, Konradsreuth (DE); Alexander Schindler, Leupoldsgrün (DE); Thorsten Hachmann, Thierstein (DE); Thomas Denner, Selb (DE); Johannes Dunkel, Rehau (DE); Andreas Postel, Oberkotzau (DE); Michael Müller, Trabitz, (DE)

(21) Appl. No.: 19/317,387

(22) Filed: Sep. 3, 2025

(30) Foreign Application Priority Data
Sep. 12, 2024 (DE) 10 2024 126 299.0

(51) Int. Cl. G01N 25/02; G06N 20/00

(52) U.S. Cl. CPC G01N 25/02; G06N 20/00

(57) ABSTRACT

A method and a device for evaluating a measuring signal of a thermal analysis. The device has a data interface, which is configured to receive the measuring signal of the thermal analysis, wherein the measuring signal specifies a measurement curve, which is based on a temperature series, and a processing logic. The processing logic is configured to determine a number of sliding windows based on the measuring signal, wherein each sliding window is assigned to a corresponding section of the measurement curve with a number of measuring points, and to determine by means of an artificial intelligence module, which is carried out by the processing logic and which is configured for the classification, whether a thermal effect of a sample material, on which the thermal analysis is based, is present for the respective one of the number of sliding windows, wherein the artificial intelligence module is configured to determine a contiguous section of the thermal effect based on the measurement curve.

### TECHNICAL FIELD

The present invention relates to the field of thermal analysis, in particular with regard to the evaluating of a measuring signal of a thermal analysis. The invention in particular relates to a method and a device for evaluating a measuring signal of a thermal analysis, a method and a device for generating training data for an artificial intelligence module, a corresponding computer-readable medium with such training data, a computer program and a corresponding computer-readable medium.

### BACKGROUND

A thermal analysis can be understood to be different methods, in the case of which physical and/or chemical properties of a substance, of a substance mixture and/or of reaction mixtures are measured as a function of the temperature or of the time, wherein the analyzed sample is subjected to a defined and/or controlled temperature program.

A thermoanalytical method is, for example, the differential scanning calorimetry (DSC), in the case of which a difference of a heat flow of a reference crucible and of a crucible with a sample body is measured as a function of temperature and/or of time. After carrying out this measurement, one or several energetic effects, which become noticeable in the measurement, for example by appearance of a peak, e.g., due to melting of a material, or a step, e.g., during the glass transition, can be evaluated on the basis of the measuring data.

The evaluating of such a measurement for energetic effects usually takes place manually. For example, the standard DIN EN ISO 11357.2, “Differential scanning calorimetry (DSC)—Part 2: Determination of glass transition temperature and of the glass transition step height” for the manual determination of the glass transition temperature specifies the equal-areas method, the inflection-point method and the half-step-height method. For the manual evaluation of a peak, which can indicate, e.g., a melting of the material during the heat-up of the sample, for example, an area of the peak can be determined, wherein the enthalpy of the energetic effect, thus the amount of heat absorbed or emitted, respectively, in this process, can be determined by means of this area.

For example, the EP 2 824 450 A1 deals with the automation of the evaluation of a measurement of the thermal analysis. By using a program-controlled computing device, at least a probability of the correspondence of the measuring result with at least one dataset previously stored in the computing device is calculated thereby. This calculation is based on a comparison of effect data previously extracted from a measurement curve of the thermal analysis with corresponding stored effect data of the dataset. In contrast, a rather data-driven approach would be desirable for the evaluation.

For the thermal analysis of a substance sample, the EP 4 209 781 A1 proposes to provide first data to a first software module. The first software module is configured to calculate a thermoanalytical measurement curve from the first data, wherein the thermoanalytical measurement curve provides for the identification of the thermal effect and outputs second data, which is suitable for displaying the measurement curve, wherein the method further comprises providing the second data to a second software module, wherein the second software module comprises an artificial intelligence, which is configured for automatically identifying thermal effects. The second software module is configured to output third data, which is representative for the thermal effect, which is automatically identified by the artificial intelligence. The artificial intelligence comprises at least one neural network. In contrast, an alternative approach, which can manage without a neural network, would be desirable.

### SUMMARY

It is an object of the invention to create the simplest possible option for evaluating a measuring signal of a thermal analysis in a manner, which is as automated as possible.

This object is solved by means of the subject matters of the independent claims. Advantageous further developments of the invention are subject matter of the dependent claims.

According to a first aspect, a method for evaluating a measuring signal of a thermal analysis is proposed. The method comprises a receiving of the measuring signal of the thermal analysis, wherein the measuring signal specifies a measurement curve, which is based on a temperature series. The method additionally comprises a determining of a number of sliding windows based on the measuring signal, wherein each sliding window is assigned to a corresponding section of the measurement curve with a number of measuring points. The method furthermore comprises a determining, by means of an artificial intelligence module configured for the classification, whether a thermal effect of a sample, which forms the basis for the thermal analysis, is present for the respective one of the number of sliding windows, wherein the artificial intelligence module determines a contiguous section of the thermal effect based on the measurement curve.

The proposed method makes it possible to achieve a high degree of automation during the evaluation of a measuring signal of a thermal analysis by means of means, which can be technically implemented easily. The method allows to reliably detect the thermal effects included in the measurement or measurement curve, respectively, and to determine the effect limits thereof as accurately as possible in an automated manner on the basis of the artificial intelligence module, which is configured for the classification. The use of the number of sliding windows allow to use more than only the information of a single measuring point for the classification of the individual measuring points, wherein the measurement curve is observed in a surrounding area of the measuring point, which is to be classified. At the same time, not the entire measurement curve but only individual curve sections and/or points are classified, in order to detect or to determine, respectively, the thermal effect. The evaluation of the measuring signal can be provided and/or output as correspondingly generated data with the thermal effect detected therein.

The methods and devices described herein can be used in numerous technical applications, such as, for example, in laboratory applications, in the production of goods, in the processing of goods, or the like.

The method can be carried out and/or executed by means of the device described herein or generally by means of a computing device, a computer, a processor, a CPU, or the like. Accordingly, the method can be computer-implemented. The method can be implemented, for example, as computer program, i.e., in the form of computer commands. The measuring signal can be present and can be received in electronic, optionally digital, form. The result of the determination by means of the artificial intelligence module, i.e., the thermal effect determined as section, can be provided and/or output in the form of correspondingly generated output data. The result of the determination can be output, for example, in text form, graphically, etc.

As used herein, different methods can be understood under the generic term “thermal analysis”, which can also be referred to as thermoanalysis, in the case of which physical and/or chemical properties of a substance, of a substance mixture and/or of reaction mixtures are measured as a function of temperature or of time, wherein the sample to be analyzed is subjected to a defined and/or controlled temperature program. Even though the methods and devices described herein are explained in an exemplary manner using the example of the differential scanning calorimetry (DSC), it goes without saying that the principle, on which the methods and devices described herein are based, can also be applied to other thermal analysis methods, such as, for instance, the differential thermoanalysis (DTA), the thermogravimetric analysis (TGA), the evolved gas analysis (EGA), the thermomechanical analysis (TMA), the dynamic mechanical analysis (DMA), or the like.

The differential scanning calorimetry (DSC) used in an exemplary manner herein is a thermoanalytical method, in the case of which the difference of the heat flow of a reference, e.g., of a reference crucible, and of a sample, e.g., of a crucible with a sample body, is measured as a function of temperature and/or time. This method allows to measure the output or absorbed amount of heat, respectively, under a defined temperature program, in particular under cool-down and/or heat-up, of a sample body. A temperature difference ΔT between the sample, e.g., with the temperature T₁, and a reference, e.g., with the temperature T₂, is effected by running the temperature program, e.g., a heat-up by means of a heater, e.g., in a surrounding oven. Said temperature difference can be captured by means of at least one measuring element and a corresponding measuring circuit. The temperature difference ΔT results from different thermal capacities of sample and reference. The difference of the heat flows, which is proportional to the temperature difference, can be applied, for example, with respect to the reference temperature T₂, the time or the like. At least one of the following exemplary determinations can be carried out with the differential scanning calorimetry: melting temperature, glass transition temperature, degree of crystallization, kinetic observations of chemical reactions, specific thermal capacity, phase transitions, decomposition point and plastic determination.

The “thermal effect” used herein can be understood to be any type of thermal and/or energetic effect, which can appear during the measurement as part of the thermal analysis, e.g., during the differential scanning calorimetry, and which is reflected accordingly in the measuring signal. The thermal effect can be effected, for example, by means of a temperature change and/or a physical and/or chemical conversion of the sample material or reference material, respectively. The thermal effect can comprise and/or be attributed to, for example, a glass transition, a melting point, a crystallization process, or the like of the respective material. The thermal effect can be reflected with corresponding features in the measuring signal and/or the measurement curve. For example, the glass transition in the respective material can be displayed by means of a step, which is correspondingly present in the measurement curve, by the height difference of which the measuring signal or the corresponding measurement curve, respectively, deviates from a baseline, which would correspond to a DSC signal without thermal effect. The melting point can further, for example, be displayed by a peak in the measurement curve, i.e., a relatively sharp maximum in the course of the measurement curve, in a positive direction. The crystallization process can be displayed by a peak in the measurement curve, i.e., a relatively sharp maximum in the course of the measurement curve, in a negative direction. It becomes clear from the present disclosure, however, that the principle, on which the methods and devices described herein are based, is suitable for the detection off any thermal effect, which can appear during a thermal analysis.

The “artificial intelligence module” can be understood to be any computer-implemented method from the field of artificial intelligence, which is suitable for the evaluation of the measuring signals described here. The artificial intelligence module can be, for example, a software module, which can be executed by a computer, a processor, etc. Alternatively, or additionally, the artificial intelligence module can be hardware-implemented. The artificial intelligence module can be based on at least one algorithm, computer model or the like from the field of machine learning and/or can comprise at least one of them. In order to configure the artificial intelligence module for its classification task, it can be trained for this purpose by means of training data. The determining of the thermal effect by means of the artificial intelligence module can also be understood or referred to, respectively, as classifying and/or predicting the thermal effect.

According to a further development, the specific section of the thermal effect and/or the evaluation or its result, respectively, can be supplied to a production planning and/or control system and/or a quality control system. In the case of a use of this type, in particular the following steps can be provided: at least randomly performing a thermal analysis of produced or processed goods, respectively, and evaluation of the measuring results of the thermal analysis by means of a method of the described type, wherein an assignment of a respective measuring result to one of several classes, e.g., quality classes or material classes, can take place. It can be provided in at least some exemplary embodiments that, depending on the result of the evaluation, an intervention in the respective process. e.g., production and/or processing, is carried out in an automatic way, i.e., prompted by a computer or the like. This intervention can be, e.g., a controlled change of the mode of operation (e.g., operating parameters of at least one machine used in the process (as far as, e.g., the stopping of the machine). Alternatively, or additionally, the intervention can comprise, for example, that certain produced or processed goods, respectively, are discarded, discharged or the like from the process as waste.

In a further development, the section of the thermal effect can be determined with a lower effect limit and an upper effect limit, based on the temperature series. The upper and lower effect limit can delimit the section of the thermal effect with respect to a different thermal effect within the measurement curve or a section of the measurement curve without thermal effect. This permits an exact evaluation and/or an exact specification of the thermal effect. Several thermal effects, which are in particular different from one another, can appear or be present, respectively, within the measurement curve. The corresponding section with its lower effect limit and its upper effect limit can in each case be determined and/or specified for each individual thermal effect. The different sections and/or thermal effects can have a corresponding identifier, e.g., a corresponding label, or be identified therewith, respectively.

According to a further development, the determining of the thermal effect by means of the artificial intelligence module can further comprise an extracting of at least one respective measuring point from the number of sliding windows. The at least one respective extracted measuring point of the number of sliding windows can be supplied to the artificial intelligence module. The artificial intelligence module can determine for the respective extracted measuring point, whether the thermal effect is present for it. Based on the determination of the thermal effect, the artificial intelligence module can determine the section of the thermal effect for the respective extracted measuring points across the number of sliding windows.

For example, each of the number of sliding windows can have a defined window size. The window size can be selected, for example, depending on of how many measuring points the measurement curve consists. Each sliding window can accordingly comprise an, i.e., in each case identical, number of measuring points. Within the respective sliding window, at least one feature of the curve section of the measurement curve comprised by the respective sliding window can be extracted. The at least one feature serves for the classification or the determination, respectively, and/or detection. The at least one feature can comprise, for example, a statistical feature, such as arithmetic mean or the like, a more complex statistical feature and/or another feature, which is suitable for the characterization of the respective curve section of the measurement curve. For example, the at least one feature can be selected from: standard deviation, median, empirical loop, measure for mirror symmetry, variation coefficient, measure for point symmetry, deviation from linear regression, curvature, absolute energy, C3 statistic, first position of the maximum, data points above the mean value, area below linear connection, minimum or maximum value of the deduction, time reversal asymmetry statistic, center of gravity, or the like. The measurement curve can be passed through with a specifiable or specified step width and the defined window size. The sliding window can be slid over the measurement curve thereby, until the last step is reached. The at least one feature can be extracted and a corresponding label can be assigned in each of the steps. The assignment of the label can take place, for example, on the basis of whether the center point of the sliding window is located within the effect limits of a thermal effect. For example, a label can be assigned to each center point or each measuring point X_{Tj}, based on the corresponding at least one feature. This can be expressed, e.g., as X_{Tj}ϵ[GT, peak, N], whereby the label GT specifies, for example, that the corresponding measuring point lies within the limits xₘᵢₙ and xₘₐₓ of a glass transition (GT). The label peak specifies, for example, that the corresponding measuring point lies within the limits of a peak. The label N specifies, for example, that the measuring point lies outside a region with thermal effect, i.e., that no thermal effect is present there. The thermal effects can essentially be characterized by their form. A glass transition can effect a step in the measuring signal and/or the measurement curve. In the case of a peak, a local maximum can be present. The artificial intelligence module can determine the corresponding label for the center point of the observed sliding window based on the at least one extracted feature. This can also be understood and/or referred to as point-based classification. More than only the information of an individual measuring point is used, the curve is rather observed in a surrounding area of the measuring point, which is to be classified.

In a further development, the section of the thermal effect can be determined based on whether the respective same thermal effect was determined for adjoining extracted measuring points across the number of sliding windows. The adjoining extracted measuring points with the same thermal effect can be combined, in particular to a thermal effect. As mentioned above, at least one feature can be extracted for each sliding window, on the basis of which the artificial intelligence module determines, e.g., predicts, estimates or the like the corresponding label for the center point of the observed sliding window. Based on this, adjoining measuring points, which were characterized with the same label, can be combined to a contiguous section of the thermal effect. Due to the combination of the measuring points to a thermal effect and further post-processing steps, e.g., a plausibility check, merging of sections or the like, a determination of one or several thermal effects can then be obtained for the entire sample.

According to a further development, the determining for the at least one respective extracted measuring point can be carried out for a center region or a center point of the respective sliding window of the number of sliding windows. As mentioned above, the sliding window can be slid over the measurement curve, until the last step is reached. The at least one feature can be extracted and a corresponding label can be assigned in each of the steps. The assignment of the label can take place based on whether the center point of the sliding window is located within the effect limits of a thermal effect.

In a further development, the determining by means of the artificial intelligence module whether the thermal effect is present for the respective one of the number of sliding windows, can be carried out for different sliding window sizes. The section of the thermal effect can be determined based on whether the respective same thermal effect was predicted for different sliding window sizes. This can also be understood and/or referred to as effect-cased classification. The section of the thermal effect can thus be determined or detected as a whole, respectively.

By means of the determination and/or detection with sliding window sizes, which differ from one another, a plurality of determinations, e.g., predictions, for the same thermal effect is obtained. They can be combined to a corresponding common thermal effect.

According to a further development, the determinations for the respective measuring point obtained with the different sliding window sizes can be counted. Based on the counting, the section of the thermal effect can be determined. For example, the thermal effect can be determined by means of a majority decision. In other words, a counting of the determinations of the thermal effect, thus the effect determinations or effect predictions, respectively, can take place for the individual measuring points.

In a further development, the thermal effect can be assigned to a glass transition, a melting or a crystallization process of a material of a sample of the thermal analysis. As mentioned above, the thermal effects can essentially be characterized by their shape. A glass transition can effect a step in the measuring signal and/or in the measurement curve. In the case of a peak as a result of melting or crystallization, a local maximum can be present. This can be determined, predicted and/or classified by means of the artificial intelligence module.

According to a second aspect, a device for evaluating a measuring signal of a thermal analysis is proposed. The device has a data interface, which is configured to receive the measuring signal of the thermal analysis, wherein the measuring signal specifies a measurement curve, which is based on a temperature series. The device additionally has a processing logic, which is configured to determine a number of sliding windows based on the measuring signal, wherein each sliding window is assigned to a corresponding section of the measurement curve with a number of measuring points, and to determine by means of an artificial intelligence module, which is carried out by the processing logic and which is configured for the classification, whether a thermal effect of a sample material, on which the thermal analysis is based, is present for the respective one of the number of sliding windows. The artificial intelligence module is configured to determine a contiguous section of the thermal effect based on the measurement curve.

The device can be configured to perform or to carry out the described method according to the first aspect. The processing logic can have a computing device, a processor, a CPU, GPU or the like or can be formed as such. The processing logic can be coupled to the data interface, a data storage, etc. With respect to the possible further developments of the device, reference is made to the corresponding method according to the first aspect.

According to a further development, the artificial intelligence module can comprise at least one of a support vector machine and of a random forest method. The support vector machine and the random forest method are in each case methods of machine learning and are suitable for the classification of data. Even though it would also be conceivable to embody the artificial intelligence module with at least one neural network, e.g., a convolutional neural network (CNN), the support vector machine and the random forest method have proven to be capable of being implemented particularly easily, computationally efficiently and reliably in the determination of the thermal effect. Compared to a neural network, the support vector machine and/or the random forest method requires, e.g., a smaller dataset, less running time and less powerful hardware for its training, in order to carry out the training within a reasonable time.

According to a third aspect, a method for generating training data for an artificial intelligence module is proposed, which is to be trained for evaluating a measuring signal of a thermal analysis. The method comprises a receiving of a training dataset, which has a number of samples, in each case comprising a measuring signal of a thermal analysis and at least one thermal effect assigned to the respective measuring signal of a sample, on which the thermal analysis is based, wherein the respective measuring signal specifies a measurement curve, which is based on a temperature series or time series. The method additionally comprises an applying of a number of sliding windows to the number of samples. The method further comprises an assigning of a label to the respective one of the number of sliding windows, wherein the respective label specifies the corresponding thermal effect as a contiguous section of the thermal effect based on the respective measurement curve. The method additionally comprises a generating of training data based on the training dataset and the respective assigned label.

The number, e.g., plurality, of samples of the training dataset can be provided, for example, in the form of “sample₁ (measuring data, effects)” to “Sample_{N} (measuring data, effects)”. An individual sample can comprise the measuring data in the form of the measurement curve with a lower and upper effect limit. In order to use more than the information of an individual measuring point for the classification, the measurement curve can be observed in a surrounding area of the measuring point, which is to be classified, with the help of the number of sliding windows. As mentioned above, at least one feature of the respective curve section can be extracted within the respective sliding window. The at least one extracted feature can optionally be preprocessed, e.g., scaled.

The assigning of the respective label for the above-mentioned point-based classification can take place in that the number of sliding windows with respective defined window size and defined step width are slid over the measurement curve. The at least one feature for the respective sliding window can be extracted in each of the steps and the corresponding label can be assigned, depending on whether the center point of the observed sliding window is located within effect limits of a thermal effect, thus, e.g., peak limits, glass transition limits or outside the thermal effects. The window size used during a measurement can be dependent on how many measuring points a measurement curve consists. Alternatively, the assigning of the respective label for the above-mentioned effect-based classification, in the case of which the thermal effect is to be detected as a whole, can take place in that the number of sliding windows is not slid pointwise, i.e., measuring pointwise, with a fixed window size over the measurement curve, but the number of sliding windows is selected based on the effects occurring in the measurement curve.

In a further development, the method can further comprise a supplying of the generated training data to the or for the artificial intelligence module. The artificial intelligence module can be trained in this way for carrying out the method according to the first aspect.

A fourth aspect provides a computer-readable medium. The training data generated according to the method according to the third aspect can be stored on the computer-readable medium. Alternatively, the computer-readable medium is a data carrier signal, which transfers the training data generated according to the method according to the third aspect.

According to a fifth aspect, a device for generating training data for an artificial intelligence module is proposed, which is to be trained for evaluating a measuring signal of a thermal analysis. The device has a data interface, which is configured to receive a training dataset, which a number of samples in each case comprising a measuring signal of a thermal analysis and at least one thermal effect assigned to the respective measuring signal of a sample, on which the thermal analysis is based, wherein the respective measuring signal specifies a measurement curve, which is based on a temperature series. The device additionally has a processing logic, which is configured to apply a number of sliding windows to the number of samples, to assign a label to the respective one of the number of sliding windows, wherein the respective label specifies the corresponding thermal effect as a contiguous section of the thermal effect based on the respective measurement curve, and to generate training data based on the training dataset and the respective assigned label.

The device can be configured to perform and/or to carry out the described method according to the third aspect. The processing logic can have a computing device, a processor, a CPU or the like or can be formed as such. The processing logic can be coupled to the data interface. With regard to the possible further developments of the device, reference is made to the corresponding method according to the third aspect.

In a further development, the device can further be configured to provide the generated training data for the artificial intelligence module and/or to supply the generated training data to the artificial intelligence module.

According to a sixth aspect, a computer program is provided. The computer program comprises commands, which, when executing the computer program by a computer, prompt the latter to carry out the method according to the first aspect and/or the method according to the third aspect.

According to a seventh aspect, a computer-readable medium is provided. The computer-readable medium comprises commands, which, when executed by a computer, prompt the latter to carry out the method according to the first aspect and/or the method according to the third aspect.

It goes without saying that the above aspects and further developments can be arbitrarily combined with one another, provided that the respective combination is not explicitly ruled out.

### BRIEF DESCRIPTION OF THE DRAWINGS

The invention is described in more detail with reference to exemplary embodiments, which are illustrated in the enclosed drawings.

The enclosed drawings are included in order to provide for a further understanding of this invention and are included in this description and represent a part thereof. The drawings illustrate the embodiments of this invention and, together with the description, serve the purpose of explaining the principles of the invention. Other embodiments of this invention and many of the provided advantages of this invention can be understood easily when they become easier to understand by referring to the following detailed description. The elements of the drawings are not necessarily drawn at the same scale to one another. Identical reference numerals accordingly identify similar parts.

FIG. 1 schematically illustrates an exemplary arrangement for performing a thermal analysis and a device for evaluating a measuring signal of a thermal analysis according to one embodiment.

FIG. 2 shows an exemplary measuring signal of a thermal analysis in the form of a measurement curve with thermal effects.

FIG. 3 shows an exemplary device for generating training data for an artificial intelligence module according to one embodiment.

FIG. 4 illustrates, on the basis of a measuring signal, a first exemplary training process for an artificial intelligence module according to one embodiment.

FIG. 5 illustrates, in a block diagram, a first exemplary training process for an artificial intelligence module according to one embodiment.

FIG. 6 illustrates, in a block diagram, a first exemplary determination or detection process, respectively, for thermal effects according to one embodiment.

FIG. 7 illustrates, in a block diagram, a second exemplary training process for an artificial intelligence module according to one embodiment.

FIG. 8 illustrates, in a flowchart, a method for evaluating a measuring signal of a thermal analysis according to one embodiment.

FIG. 9 illustrates, in a flowchart, a method for generating training data for an artificial intelligence module according to one embodiment.

Unless stated otherwise, identical reference numerals identify identical or functionally similar components in the figures. All directional terms, such as, “top”, “bottom”, “left”, “right”, “above”, “below”, “horizontal”, “vertical”, “rear”, “front” and similar terms are used only for explanatory purposes and are not to limit the embodiments to the specific arrangements, which are illustrated in the drawings.

### DETAILED DESCRIPTION

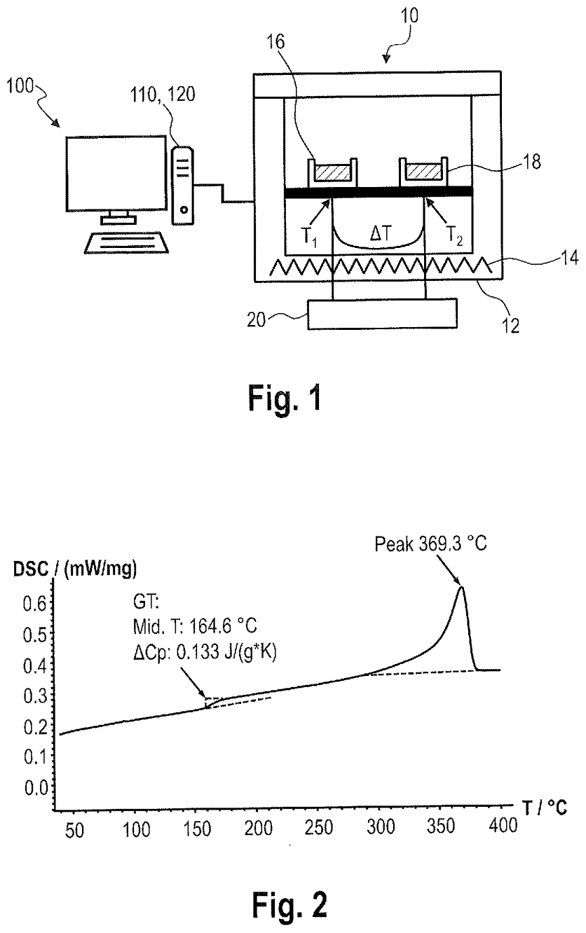

FIG. 1 schematically illustrates an exemplary arrangement 10 for performing a thermal analysis. FIG. 1 additionally shows an exemplary device 100 for evaluating a measuring signal of a thermal analysis.

The differential scanning calorimetry (DSC) used in an exemplary manner here is a thermoanalytical method, in the case of which the difference of a heat flow of a reference, e.g., of a reference crucible, and of a sample, e.g., of a crucible with a sample body, is measured as a function of temperature and/or time. This method allows to measure the output or absorbed amount of heat, respectively, under a defined temperature program, in particular under cool-down and/or heat-up, of a sample body. The arrangement 10 has an oven 12 with a heating apparatus 14, e.g., a heating coil. The arrangement 10 additionally has a sample 16 to be analyzed, e.g., the crucible with the sample body, and a reference 18, e.g., the reference crucible. The arrangement furthermore has at least one measuring element for measuring the temperature of the respective temperature T₁, T₂ of the sample 16 and reference 18 as well as a corresponding measuring circuit 20, which is configured to determine the temperature difference ΔT from the temperature measurement. The sample 16 and the reference 18 have different thermal capacities compared to one another. The difference of the heat flows of the sample 16 and of the reference 18 is at least essentially proportional to the temperature different ΔT. The difference of the heat flows can be applied, for example, with respect to the reference temperature T₂ or with respect to time. At least one of the following exemplary determinations can be carried out with the DSC: melting temperature, glass transition temperature, degree of crystallization, kinetic observations of chemical reactions, specific thermal capacity, phase transitions, decomposition point and plastic determination. The arrangement 10 is configured to generate and/or to provide a corresponding measuring signal, wherein the measuring signal specifies a measurement curve, which is based on a temperature series.

The device 100 is configured to receive and to evaluate the measuring signal of the thermal analysis. The device 100 has a data interface 110, which is configured to receive the measuring signals of the thermal analysis. The device 100 additionally has a processing logic 120, which is coupled to the data interface 110 and which is configured to process the received measuring signal, in particular to evaluate it. The processing logic 120 can have, for example, a computing device, a processor, a CPU, GPU or the like or can be formed as such. Only for a better illustration, the device 100 is illustrated as computer, e.g., desktop computer or workstation here. However, the device 100 can also be a device of the arrangement 10 and can be formed, for example, by means of a dedicated equipment.

The processing logic 120 is configured to determine a number of sliding windows based on the measuring signal. Each of these sliding windows is assigned to a corresponding section of the measurement curve with a number of measuring points. The processing logic 120 is additionally configured to determine by means of an artificial intelligence module, which is carried out by the processing logic 120 and which is configured for the classification, whether a thermal effect of a sample material, on which the thermal analysis is based, is present for the respective one of the number of sliding windows. The artificial intelligence module is configured to determine a contiguous section of the thermal effect based on the measurement curve.

The artificial intelligence module can comprise, for example, at least one of a support vector machine and of a random forest method. The support vector machine and the random forest method are in each case methods of machine learning and are suitable for the classification of data. Even though it would also be conceivable to embody the artificial intelligence module with at least one neural network, e.g., a convolutional neural network (CNN), the support vector machine and the random forest method have proven to be capable of being implemented particularly easily, computationally efficiently and reliably in the determination of the thermal effect.

For the determination of the at least one thermal effect, two exemplary approaches are described further below, namely a point-based classification and an effect-based classification.

FIG. 2 shows an exemplary measuring signal of a thermal analysis in the form of a measurement curve with thermal effects. The measuring signal originates from the arrangement 10 and can be processed or evaluated, respectively, by means of the device 100.

Two exemplary thermal effects are included in the measuring signal. A glass transition in the material of the sample 16 is identified with “GT”, which presents itself as step in the measuring signal or which is characterized by such a step, respectively. “Peak” refers to a melting of the material of the sample 16 here, wherein a similar characteristic could appear in the negative direction during a crystallization process of the material of the sample 16, which could likewise be determined by means of the device 100. The melting point is characterized by the peak in the measurement curve, i.e., a relatively sharp maximum.

The device 100 is configured to evaluate such thermal effects in the measuring signal in an automated manner.

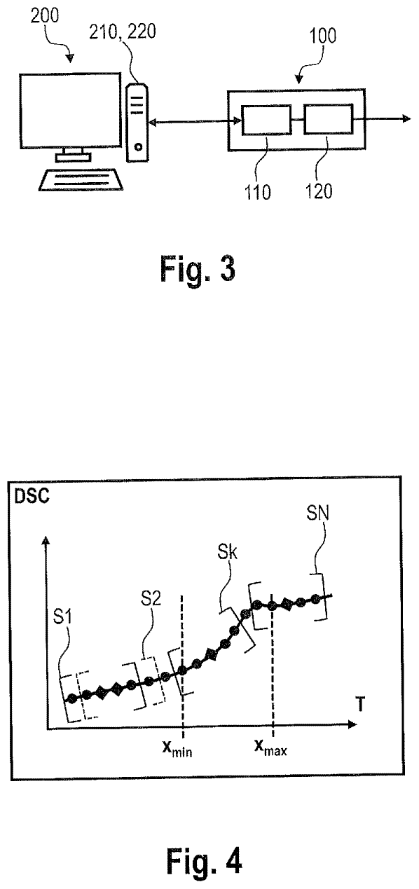

FIG. 3 shows an exemplary device 200 for generating training data for the artificial intelligence module of the device 100. The device 200 can be coupled or respectively, according to FIG. 3 is coupled to the device 100.

The device 200 has a data interface 210 and a processing logic 220, which are coupled to one another. The processing logic 220 can have, for example, a computing device, a processor, a CPU, GPU or the like or can be formed as such. Only for a better illustration, the device 200 is illustrated as computer, e.g., desktop computer or workstation here.

The data interface 210 is configured to receive a training dataset, which comprises a number of samples in each case comprising a measuring signal of a thermal analysis and at least one thermal effect assigned to the respective measuring signal of a sample, on which the thermal analysis is based. The respective measuring signal specifies a measurement curve, which is based on a temperature series. The processing logic 220 is configured to apply a number of sliding windows to the number of samples. The processing logic 220 is additionally configured to assign a label to the respective one of the number of sliding windows, wherein the respective label specifies the corresponding thermal effect as a contiguous section of the thermal effect based on the respective measurement curve. The processing logic 220 is furthermore configured to generate training data based on the training dataset and the respective assigned label.

The device 200 is additionally configured to provide the generated training data for the artificial intelligence module, e.g., via the data interface 210 and/or to supply the generated training data to the artificial intelligence module of the device 100.

For the training of the artificial intelligence module of the device 100 by means of the device 200, two exemplary approaches are described further below, namely a point-based and an effect-based approach.

FIG. 4 illustrates, on the basis of a measuring signal, a first exemplary training process for the artificial intelligence module of the device 100. The training process according to FIG. 4 can be understood or referred to, respectively, as point-based approach or point-based classification.

The measuring signal is present as measurement curve with a number of measuring points. The measuring points are generally illustrated as round points. A number of sliding windows are applied to the measuring points. In other words, the number of sliding windows are slid over the measurement curve and/or the measuring points. For a better illustration, the respective center points of the sliding windows are illustrated as rhombus in FIG. 4. The sliding windows are illustrated as square brackets.

In the case of the point-based training process, the detection process of the region of the thermal effect is traced back to a classification of the individual measuring points included in the measurement curve. Concretely, a label is to thus be assigned to each measuring point X_{Tj}, which can be expressed, for example, as X_{Tj}ϵ[GT, peak, N], whereby the label GT means that the point lies within the limits or effect limits xₘᵢₙ and xₘₐₓ, respectively, of a glass transition. Accordingly, for the label peak within the limits of a peak. The label N means that the measuring point lies outside the regions, in which the thermal effects or energetic effects, respectively, take place. As mentioned above, the thermal effects are essentially characterized by their form. In the case of a glass transition, a stage can be recognized in the measuring signal. In the case of a peak, a local maximum is present in the curve progression of the measurement curve. Different features for this curve section are extracted within the respective sliding window. They serve to train the classifier. Possible features, which can be extracted within the respective sliding window, are, for example, the standard deviation or the arithmetic mean of the observed section, wherein other and/or further features are conceivable. The respective sliding window is slid over the measurement curve with a window size N_{W} during the training process of the point-based classification, until the last step is reached. The window size N_{W} determines how many measuring points are located within the respective sliding window. The features for this sliding window are extracted in each of the steps and the corresponding label, depending on whether the center point of the observed window is located within peak limits, glass transition limits or outside the effects.

The sliding window size N_{W}=5 is only exemplary in FIG. 4. The sliding window size used during a measurement can be selected, for example, depending on how many measuring points the measurement curve has. This can be accomplished, for example, a coefficient, by which the number of the measuring points is divided. For example, a sliding window coefficient wₖ=5 for a measurement, which comprises N=1500 measuring points and which extends over a temperature range of 300K. The number of the points observed in a sliding window is thereby N_{W}=3000 and the sliding window extends over a temperature range of 60K. According to FIG. 4, the label “N” can be assigned in response to the sliding of the sliding window over the measurement curve in a first step S1, in a second step S2 and in a last step SN. The label “GT” to the sliding window in step Sk because the center point of this sliding window is located within the limits of a glass transition. As mentioned above, the assignment of the label can take place based on whether the center point of the respective sliding window is located within the effect limits of a thermal effect.

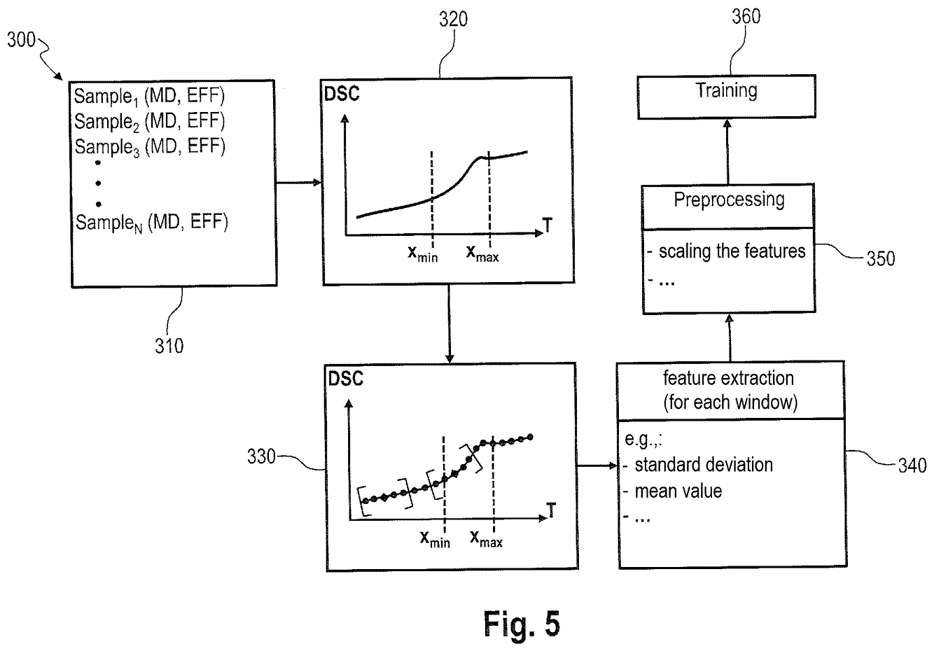

FIG. 5 illustrates the first exemplary training process for the artificial intelligence module of the device 100 from FIG. 4 in a block diagram 300 with the blocks 310 to 360. The training process is therefore also point-based here.

In block 310, a training dataset is received via the data interface 210 of the device 200, which has a number N of samples, in each case comprising a measuring signal MD of the thermal analysis and which comprises at least one thermal effect EFF assigned to the respective measuring signal MS of a sample, on which the thermal analysis is based.

The respective measuring signal MD specifies a measurement curve, as it is illustrated in block 320, which is based on a temperature series.

According to block 330, the processing logic 220 is configured to apply a number of sliding windows to the number of samples. For example, each of the number of sliding windows can have a defined window size. The window size can be selected, for example, depending on how many measuring points the measurement curve consists. Each sliding window can accordingly comprise an, i.e., in each case identical, number of measuring points.

According to block 340, at least one feature of the curve section of the measurement curve, which is comprised by the respective sliding window, will be extracted within the respective sliding window. The at least one feature serves for the classification or the determination, respectively, and/or detection. The at least one feature can comprise, for example, a statistical feature, such as arithmetic mean or the like, a more complex statistical feature and/or another feature, which is suitable for the characterization of the respective curve section of the measurement curve. For example, the at least one feature can be selected from: standard deviation, median, empirical loop, measure for mirror symmetry, variation coefficient, measure for point symmetry, deviation from linear regression, curvature, absolute energy, C3 statistic, first position of the maximum, data points above the mean value, area below linear connection, minimum or maximum value of the deduction, time reversal asymmetry statistic, center of gravity, or the like. The measurement curve can be passed through with a specifiable or specified step width and the defined window size. The sliding window can be slid over the measurement curve thereby, until the last step is reached. The at least one feature can be extracted and a corresponding label can be assigned in each of the steps. The assignment of the label can take place, for example, on the basis of whether the center point of the sliding window is located within the effect limits of a thermal effect. For example, a label can be assigned to each center point or each measuring point X_{Tj}, based on the corresponding at least one feature. This can be expressed, e.g., as X_{Tj}ϵ[GT, peak, N], whereby the label GT specifies, for example, that the corresponding measuring point lies within the limits xₘᵢₙ and xₘₐₓ of a glass transition (GT). The label peak specifies, for example, that the corresponding measuring point lies within the limits of a peak. The label N specifies, for example, that the measuring point lies outside a region with thermal effect, i.e., that no thermal effect is present there. The section of the thermal effect can be determined based on whether the respective same thermal effect was determined for adjoining extracted measuring points across the number of sliding windows. The adjoining extracted measuring points with the same thermal effect can be combined, in particular to a thermal effect.

According to block 350, the at least one extracted feature can be preprocessed, e.g., scaled.

According to block 360, the processing logic 220 is configured to generate training data based on the training dataset and the respectively assigned label. Said training data can be supplied to the artificial intelligence module.

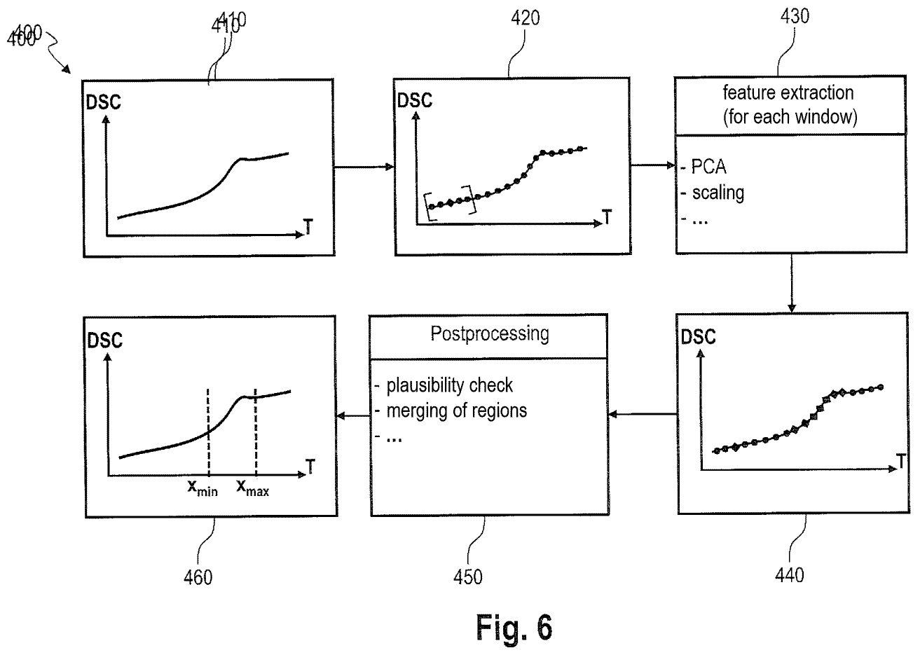

FIG. 6 illustrates a first exemplary determination or detection process, respectively, for thermal effects of the device 100 in a block diagram 400 with the blocks 410 to 460. The determination or detection, respectively, of the thermal effects takes place analogously to the first exemplary training process in a point-based manner here.

The thermal effects included in the measurement curve can be detected or determined, respectively, and the limits xₘᵢₙ and xₘₐₓ thereof can be determined during the detection process on the basis of the artificial intelligence module of the device 100, which was trained by means of the first exemplary training process. The procedure for the detection of the effects is analogous to the procedure of the training process according to FIG. 4 and FIG. 5.

Further with reference to FIG. 6, the measuring signal is received or obtained, respectively, in block 410. According to block 420, the measurement curve is passed through with specified step width and defined sliding windows. According to block 430, features are extracted for each sliding window and are transformed with the preprocessing steps adapted during the training. Based on these features, the artificial intelligence module according to block 440 makes a prediction or a determination, respectively, for the label of the center point of the observed sliding window. By means of subsequent postprocessing of the predicted labels for the measuring points, adjoining points, which were identified with the label of the same effect, are combined to an effect region in block 450. The determination or prediction, respectively, of the entire sample together with effect limits is obtained according to block 460 by means of the combination of the points to a thermal effect as well as optional further postprocessing steps.

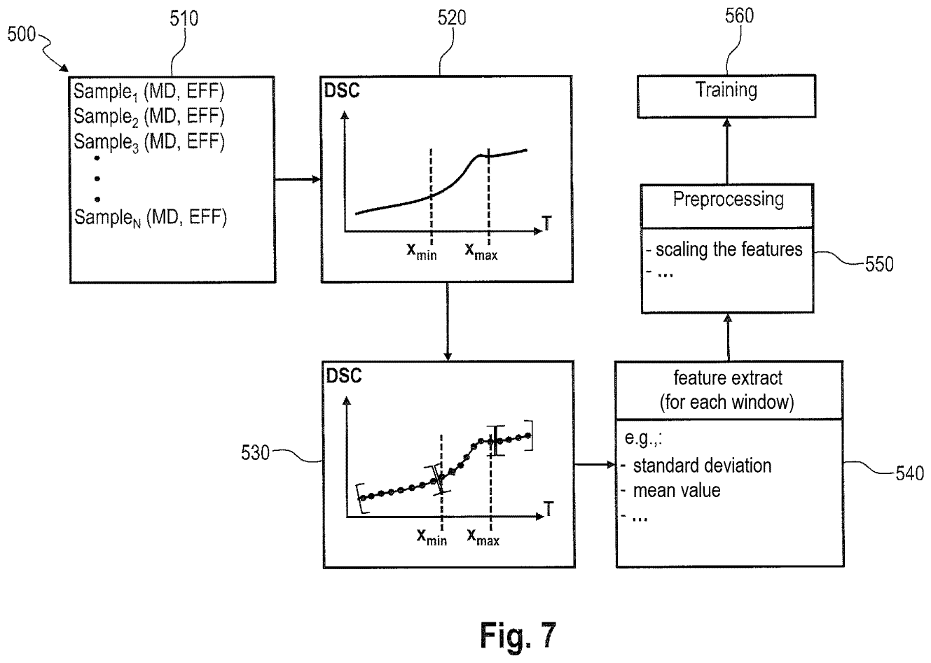

FIG. 7 illustrates a second exemplary training process for an artificial intelligence module in a block diagram 500 with the blocks 510 to 560. The training process according to FIG. 7 can be understood or referred to, respectively, as effect-based approach or effect-based classification. In contrast to the above-mentioned point-based approach, the sliding windows are not slid pointwise with a fixed window size over the measurement curve in the case of the effect-based approach, but the sliding windows are selected based on the effects occurring in the measurement curve. A difference compared to the point-based approach is the number of the training examples because the number of the thermal effects is significantly smaller than the number of the measuring points, which are included in the measurement curve. In the example according to block 530, three training samples would be obtained, two without thermal effect and one with thermal effect, namely a glass transition between the effect limits xₘᵢₙ and xₘₐₓ.

In block 510, a training dataset is received in block 510 via the data interface 210 of the device 200, which training dataset comprises a number N of samples in each case comprising a measuring signal MD of the thermal analysis and at least one thermal effect EFF assigned to the respective measuring signal MS of a sample, which forms the basis for the thermal analysis. The respective measuring signal MD specifies a measurement curve, which is based on a temperature series, as it is illustrated in block 520. According to block 530 and block 540, features are extracted from the sliding windows of the regions of the thermal effects or of the regions without thermal effect, respectively, and the corresponding labels are assigned. In the case of the example according to FIG. 7, the label “N” would be assigned to the two outer regions, i.e., the region outside the effect limits xmin and xmas because no thermal effect is present there. The label “GT” would be assigned to the center region, i.e., the regions within the effect limits xmin and xmax because this is a glass transition. According to block 550, the extracted features can be preprocessed, e.g., scaled, e.g., by means of normalization, standardization or the like. According to block 560, the processing logic 220 is configured to generate training data based on the training dataset and the respective assigned label. This training data can be supplied to the artificial intelligence module.

The effect-based determination process or detection process, respectively, is carried out for different sliding window sizes because the regions of the thermal effects partially differ significantly in their length. A plurality of predications for the same effect are to be expected due to the detection with different sliding window sizes. These effects can subsequently be brought together to a common thermal effect. For this purpose, a counting of the effect predictions for the individual measuring points can be carried out based on the predictions obtained with the different sliding window sizes. The thermal effect type to be detected can subsequently be determined by means of a majority decision.

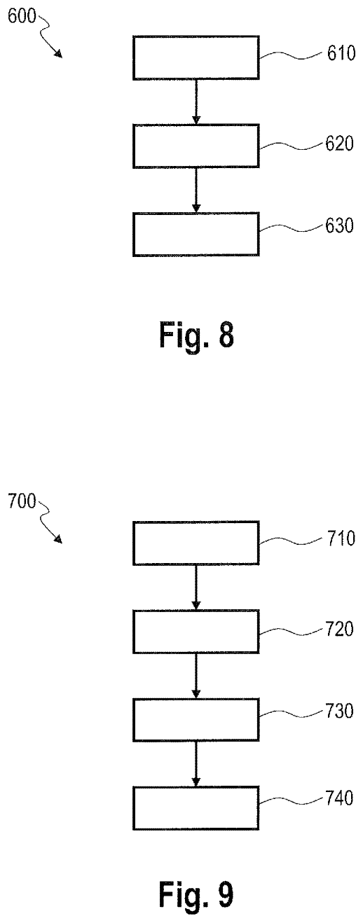

In a flowchart, FIG. 8 illustrates a method 600 for evaluating a measuring signal of a thermal analysis. The method 600 can be carried out, for example, by means of the device 100.

The method 600 comprises a receiving 610 of the measuring signal of the thermal analysis, wherein the measuring signal specifies a measurement curve, which is based on a temperature series. The method 600 additionally comprises a determining 620 of a number of sliding windows based on the measuring signal, wherein each sliding window is assigned to a corresponding section of the measurement curve with a number of measuring points. The method 600 furthermore comprises a determining 630, by means of an artificial intelligence module configured for the classification, whether a thermal effect of a sample, on which the thermal analysis is based, is present for the respective one of the number of sliding windows. The artificial intelligence module thereby determines a contiguous section of the thermal effect based on the measurement curve.

In a flowchart, FIG. 9 illustrates a method 700 for generating training data for an artificial intelligence module. The method 700 can be carried out, for example, by means of the device 200.

The method 700 comprises a receiving 710 of a training dataset, which has a number of samples, in each case comprising a measuring signal of a thermal analysis and at least one thermal effect assigned to the respective measuring signal of a sample, on which the thermal analysis is based, wherein the respective measuring signal specifies a measurement curve, which is based on a temperature series or time series. The method 700 additionally comprises an applying 720 of a number of sliding windows to the number of samples. The method 700 further comprises an assigning 730 of a label to the respective one of the number of sliding windows, wherein the respective label specifies the corresponding thermal effect as a contiguous section of the thermal effect based on the respective measurement curve. The method 700 additionally comprises a generating 740 of training data based on the training dataset and the respective assigned label.

1. A method for evaluating a measuring signal of a thermal analysis, wherein the method comprises:
receiving the measuring signal of the thermal analysis, wherein the measuring signal specifies a measurement curve, which is based on a temperature series,
determining a number of sliding windows based on the measuring signal, wherein each sliding window is assigned to a corresponding section of the measurement curve with a number of measuring points and
determining, by means of an artificial intelligence module configured for the classification, whether a thermal effect of a sample, which forms the basis for the thermal analysis, is present for the respective one of the number of sliding windows, wherein the artificial intelligence module determines a contiguous section of the thermal effect based on the measurement curve.

2. The method according to claim 1, wherein the specific section of the thermal effect is supplied to a production planning and/or control system and/or a quality control system.

3. The method according to claim 1, wherein the section of the thermal effect is determined with a lower effect limit and an upper effect limit, based on the temperature series, and wherein the upper and lower effect limit delimit the section of the thermal effect with respect to a different thermal effect within the measurement curve or a section of the measurement curve without thermal effect.

4. The method according to claim 1, wherein the determining of the thermal effect by means of the artificial intelligence module further comprises:
extracting at least one respective measuring point from the number of sliding windows and
supplying the at least one respective extracted measuring point of the number of sliding windows to the artificial intelligence module, wherein the artificial intelligence module determines for the respective extracted measuring point, whether the thermal effect is present for it, and, based on the determination of the thermal effect, determines the section of the thermal effect for the respective extracted measuring points across the number of sliding windows.

5. The method according to claim 4, wherein the section of the thermal effect is determined based on whether the respective same thermal effect was predicted for adjoining extracted measuring points across the number of sliding windows, and wherein the adjoining extracted measuring points with the same thermal effect are combined.

6. The method according to claim 4, wherein the determining for the at least one respective extracted measuring point is carried out for a center region or a center point of the respective sliding window of the number of sliding windows.

7. The method according to claim 1, wherein the determining by means of the artificial intelligence module whether the thermal effect is present for the respective one of the number of sliding windows, is carried out for different sliding window sizes and the section of the thermal effect is determined based on whether the respective same thermal effect was determined for different sliding window sizes.

8. The method according to claim 7, wherein the determinations for the respective measuring point obtained with the different sliding window sizes is counted and, based on the counting, the section of the thermal effect is determined.

9. The method according to claim 1, wherein the thermal effect is assigned to a glass transition, a melting or a crystallization process of a material of a sample of the thermal analysis.

10. A device for evaluating a measuring signal of a thermal analysis, comprising:
a data interface, which is configured to receive the measuring signal of the thermal analysis, wherein the measuring signal specifies a measurement curve, which is based on a temperature series, and
a processing logic, which is configured:
to determine a number of sliding windows based on the measuring signal, wherein each sliding window is assigned to a corresponding section of the measurement curve with a number of measuring points, and to determine by means of an artificial intelligence module, which is carried out by the processing logic and which is configured for the classification, whether a thermal effect of a sample material, on which the thermal analysis is based, is present for the respective one of the number of sliding windows, wherein the artificial intelligence module is configured to determine a contiguous section of the thermal effect based on the measurement curve.

11. The device according to claim 10, wherein the artificial intelligence module comprises at least one of a support vector machine and a random forest method.

12. A method for generating training data for an artificial intelligence module, which is to be trained for evaluating a measuring signal of a thermal analysis, wherein the method comprises:
receiving a training dataset, which has a number of samples, in each case having a measuring signal of a thermal analysis and at least one thermal effect assigned to the respective measuring signal of a sample, on which the thermal analysis is based, wherein the respective measuring signal specifies a measurement curve, which is based on a temperature series or time series,
applying a number of sliding windows to the number of samples,
assigning a label to the respective one of the number of sliding windows, wherein the respective label specifies the corresponding thermal effect as a contiguous section of the thermal effect based on the respective measurement curve, and
generating training data based on the training dataset and the respective assigned label.

13. The method according to claim 12, further comprising:
supplying the generated training data to the artificial intelligence module.

14. A computer-readable medium, on which the training data generated for an artificial intelligence module, which is to be trained for evaluating a measuring signal of a thermal analysis, wherein the method includes:
receiving a training dataset, which has a number of samples, in each case having a measuring signal of a thermal analysis and at least one thermal effect assigned to the respective measuring signal of a sample, on which the thermal analysis is based, wherein the respective measuring signal specifies a measurement curve, which is based on a temperature series or time series,
applying a number of sliding windows to the number of samples,
assigning a label to the respective one of the number of sliding windows, wherein the respective label specifies the corresponding thermal effect as a contiguous section of the thermal effect based on the respective measurement curve, and
generating training data based on the training dataset and the respective assigned label and is stored, or data carrier signal, which transfers the training data generated.

15. A device for generating training data for an artificial intelligence module, which is to be trained for evaluating a measuring signal of a thermal analysis, the device comprising:
a data interface, which is configured to receive a training dataset, which a number of samples in each case comprising a measuring signal of a thermal analysis and at least one thermal effect assigned to the respective measuring signal of a sample, on which the thermal analysis is based, wherein the respective measuring signal specifies a measurement curve, which is based on a temperature series, and
a processing logic, which is configured:
to apply a number of sliding windows to the number of samples, to assign a label to the respective one of the number of sliding windows, wherein the respective label specifies the corresponding thermal effect as a contiguous section of the thermal effect based on the respective measurement curve, and
to generate training data based on the training dataset and the respective assigned label.

16. The device according to claim 15, wherein the device is further configured to provide the generated training data for the artificial intelligence module and/or to supply the generated training data to the artificial intelligence module.

17. A computer program, comprising commands, which, when executed by a computer, prompt the computer to carry out a method for an artificial intelligence module, which is to be trained for evaluating a measuring signal of a thermal analysis, wherein the method includes:
receiving a training dataset, which has a number of samples, in each case having a measuring signal of a thermal analysis and at least one thermal effect assigned to the respective measuring signal of a sample, on which the thermal analysis is based, wherein the respective measuring signal specifies a measurement curve, which is based on a temperature series or time series,
applying a number of sliding windows to the number of samples,
assigning a label to the respective one of the number of sliding windows, wherein the respective label specifies the corresponding thermal effect as a contiguous section of the thermal effect based on the respective measurement curve, and
generating training data based on the training dataset and the respective assigned label and is stored, or data carrier signal, which transfers the training data generated.

18. A computer-readable medium, comprising commands, which, when executed by a computer, prompt the computer to carry out a method for an artificial intelligence module, which is to be trained for evaluating a measuring signal of a thermal analysis, wherein the method includes:
receiving a training dataset, which has a number of samples, in each case having a measuring signal of a thermal analysis and at least one thermal effect assigned to the respective measuring signal of a sample, on which the thermal analysis is based, wherein the respective measuring signal specifies a measurement curve, which is based on a temperature series or time series,
applying a number of sliding windows to the number of samples,
assigning a label to the respective one of the number of sliding windows, wherein the respective label specifies the corresponding thermal effect as a contiguous section of the thermal effect based on the respective measurement curve, and
generating training data based on the training dataset and the respective assigned label and is stored, or data carrier signal, which transfers the training data generated.

19. The method according to claim 2, wherein the section of the thermal effect is determined with a lower effect limit and an upper effect limit, based on the temperature series, and wherein the upper and lower effect limit delimit the section of the thermal effect with respect to a different thermal effect within the measurement curve or a section of the measurement curve without thermal effect.

20. The method according to claim 2, wherein the determining of the thermal effect by means of the artificial intelligence module further comprises:
extracting at least one respective measuring point from the number of sliding windows and
supplying the at least one respective extracted measuring point of the number of sliding windows to the artificial intelligence module, wherein the artificial intelligence module determines for the respective extracted measuring point, whether the thermal effect is present for it, and, based on the determination of the thermal effect, determines the section of the thermal effect for the respective extracted measuring points across the number of sliding windows.
